(19) United States
(12) Patent Application Publication
(10) Pub. No.: US 2002/0010753 A1
(43) Pub. Date: Jan. 24, 2002

(54) Method and apparatus for delivering dynamic information in a computer network

(76) Inventors: Robert M. Matsuoka, New York, NY (US); Andrey Akselrod, Brooklyn, NY (US)

Correspondence Address: STROOCK & STROOCK & LAVAN LLP, 180 Maiden Lane, New York, NY, 10038, US

(21) Appl. No.: 09/739,591

(22) Filed: Dec. 18, 2000

Related U.S. Application Data
(60) Provisional application No. 60/172,770, filed on Dec. 20, 1999.

(51) Int. Cl. G06F 15/16

(52) U.S. Cl. 709/217

(57) ABSTRACT

A method and apparatus for obtaining information in a computer network includes requesting information from a server, and determining whether the information has been pre-stored in a server controlled cache. If the requested information has been pre-stored in the cache, the information is retrieved from memory. Otherwise, the information is obtained from the network, and a copy of the requested information is stored in the cache. In one embodiment of the invention, dynamic web pages are delivered to an Internet browser for viewing by a personal computer user.

This claims the benefit of copending U. S. Provisional Patent Application No. 60/172,770 filed Dec. 20, 1999.

### FIELD OF THE INVENTION

This invention relates to obtaining information from a computer network, and more particularly to quickly delivering web pages that include user input.

### BACKGROUND OF THE INVENTION

The popularity of using the Internet to exchange information is continuously increasing. Users access the world wide web, for example, to obtain information by viewing web pages that may include text, image, audio and/or video data. Companies and agencies commonly use the world wide web to collect information from potential and current clients and customers.

The world wide web operates on a client server model. That is, personal computer users typically use browsers (web clients) which contact servers to request information. These servers contact other computers that are connected to the world wide web, obtain the requested information and return it to the browser. The returned information is typically in the form of a HyperText Markup Language (HTML) file which is interpreted by the browser and displayed as a user viewable web page.

Quite often, a single user will request the same web page multiple times. For example, a user may check a particular web site at the end of each business day to obtain a stock market report, or she may repeatedly check a particular web site to check news, sports scores or weather information. Without intervention, the same request would have to be processed each time the user wishes to obtain the information. This means that the browser would repeatedly have to contact the server, which would in turn contact the appropriate networked computer to retrieve and return the requested data. Because processing a request for a web page often takes a great deal of time, repeating these steps can become very frustrating for the user and cause her to avoid the web site.

To avoid this problem, browsers often include cache functions. A cache is a temporary storage area, that can include essentially any type of memory including random access memory, nonvolatile storage and the like. It typically includes expiration rules which dictate when the information will be purged. When a cache is used, the browser only has to contact the server once to obtain the request from the world wide web, rather than having to request the same page multiple times. Once the file is received it is stored in the cache, and flow subsequent requests for the same page are processed by retrieving the file from the cache, updating the file if necessary and delivering the cache file to the browser. This results in considerable time savings.

It is relatively simple to deliver “static” web pages (i.e. web pages that are capable only of providing information) to a browser. While delivering static web pages is relatively easy, it is somewhat more difficult to generate “dynamic” web pages (i.e. interactive web pages that enable clients and customers to input data). Examples of dynamic web pages are those that accept user input such as customer feedback, on-line order entry, and search strings. One way to generate dynamic web pages is to build a content containing database and combine it with one or more application programs. One commercially available device that can perform this function is sold under the tradename COLDFUSION, made by Allaire, Corp., of Newton, Mass. COLDFUSION consists of an Integrated Development Environment (IDE) that provides the tools that allow users to develop applications, and a Deploy Platform that allows developers and server administrators to deliver complex applications in a runtime environment. COLDFUSION enables companies to segment their web sites into distinct portions, to separately build those web site portions and to store them in a database. The web site portions are reassembled later to generate the full web site. For example, entry forms that are designed using such a device can enable a news reporter to submit information about a current event, without having to worry about web page formatting and structure details. The information can be incorporated into the web site and displayed in its proper location with respect to the titles, logos and advertisements that are ordinarily displayed there. Thus, database application programs like COLDFUSION provide the tools that assist developers in creating dynamic web pages.

While dynamic web pages often provide enhanced functionality and database access, it takes longer to return a dynamic web page from the World Wide Web to a browser than it does to return a static web page. This limits the number of users that can simultaneously visit a web site. While a browser controlled cache is a very effective way to rapidly deliver static web pages, the interactive nature of dynamic web pages makes it impractical to use a browser controlled cache to reduce the latency time for a dynamic web page. Additionally, caches that are generated by browsers have two significant drawbacks. First, they do not allow large numbers of users to share cached files. Also, they can not be precisely controlled by the application that generates the dynamic web pages.

Accordingly, although known apparatus and processes are suitable for their intended purposes, a need remains for a method and apparatus capable of building dynamic web pages in a relatively short time period which can quickly deliver such web pages to a user once they have been requested, which allows many users to share cached web pages ince they have been generated, and which allows the dynamic web application to update cache files as needed.

### SUMMARY OF THE INVENTION

The invention satisfies the foregoing and other needs and is generally directed to a method and system of providing dynamic information to users of a computer network.

According to an embodiment of the invention a request for information is received at a server in the computer network, and a determination is made whether a copy of the requested information is present in a memory linked to the server. If the requested information is present in the memory, a copy of the requested information is retrieved from the memory and transmitted to the source of the request. If the requested information is not present in the memory, the requested information is retrieved from a computer network information source and delivered to the source of the request. A copy of the retrieved information is also placed in the memory.

One embodiment of the invention includes a method of delivering dynamic web pages to an Internet browser. A request for a page on the World Wide Web is received from the Internet browser, and a determination is made as to whether a copy of the requested web page has been previously stored in a cache linked to the server. If the requested web page has been previously stored in the cache, a copy of the requested web page is retrieved from the cache and the retrieved copy is transmitted to the Internet browser. If the requested information has not previously been stored in the cache, the requested web page is retrieved from a database application development tool and delivered to the Internet browser. A copy of the requested web page is stored in the cache.

In accordance with still another embodiment of the invention, a computer system capable of delivering dynamic information, includes a computer network information server configured to receive at least one request for information; and an information retrieval system configured to accept the at least one request for information from the network information server and to return the requested information to the network information server. The information retrieval system is further configured to (i) determine whether information responsive to the request for information is located in a memory linked to the computer network information server, (ii) transmit the information responsive to the request for information to from the memory to the server if information responsive to the request for information is located in the memory, (iii) request information responsive to the request for information from a computer network information source if information responsive to the request for information is not located in the memory, (iv) transmit information received from the computer network information source to the server, and (v) store a copy of the information received from the computer network information source in the memory.

Other embodiments of the present invention and features thereof will become apparent from the following detailed description, considered in conjunction with the accompanying drawing figures.

### BRIEF DESCRIPTION OF THE DRAWINGS

FIG. 1 is a flow chart illustrating a process for providing dynamic web pages to a user according to one embodiment of the invention;

FIG. 2 is a flow chart illustrating a general process for determining whether a requested web page has previously been stored in the cache, according to one embodiment of the invention;

FIG. 3 is a schematic illustrating the main portions of an information retrieval system according to one embodiment of the invention;

FIG. 4 is a flow chart illustrating a process for delivering web pages at an Internet browser, according to one embodiment of the invention;

FIG. 5 is a schematic illustrating a computer network according to one embodiment of the invention.

While the present invention will be described in connection with certain embodiments thereof, it is to be understood that the invention is not limited to those embodiments. On the contrary, it is intended to cover all alternatives, modifications, and equivalents as may be included within the spirit and scope of the invention as defined by the appended claims.

### DETAILED DESCRIPTION OF THE INVENTION

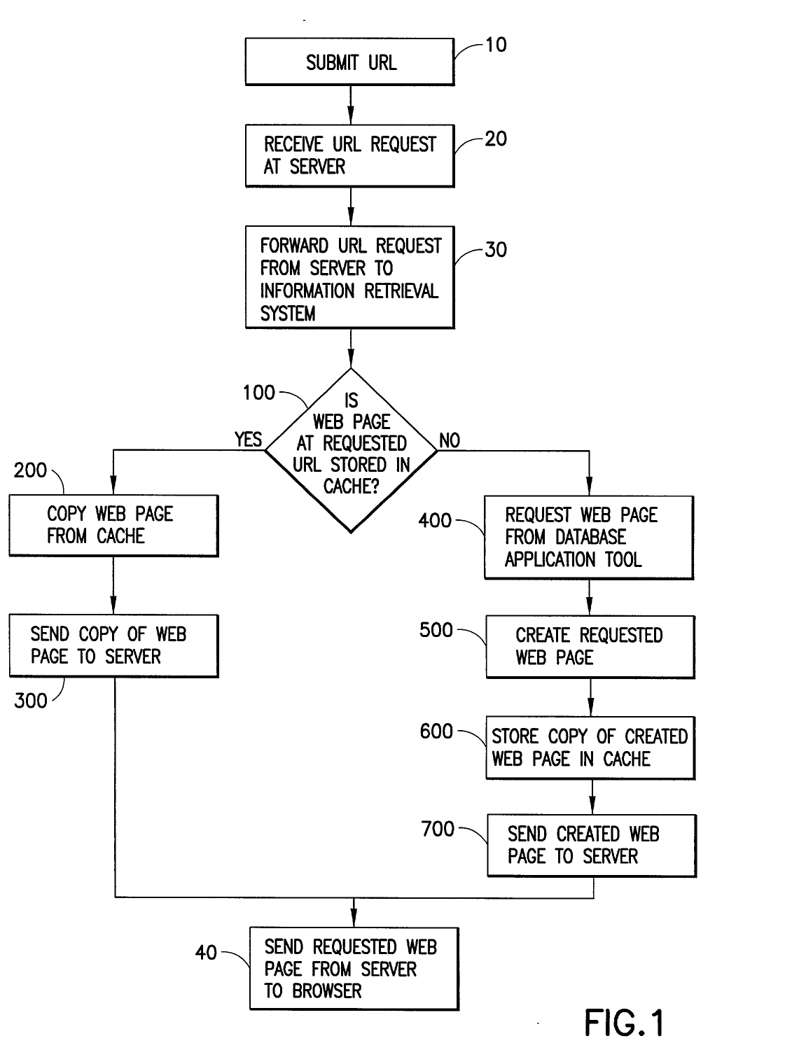

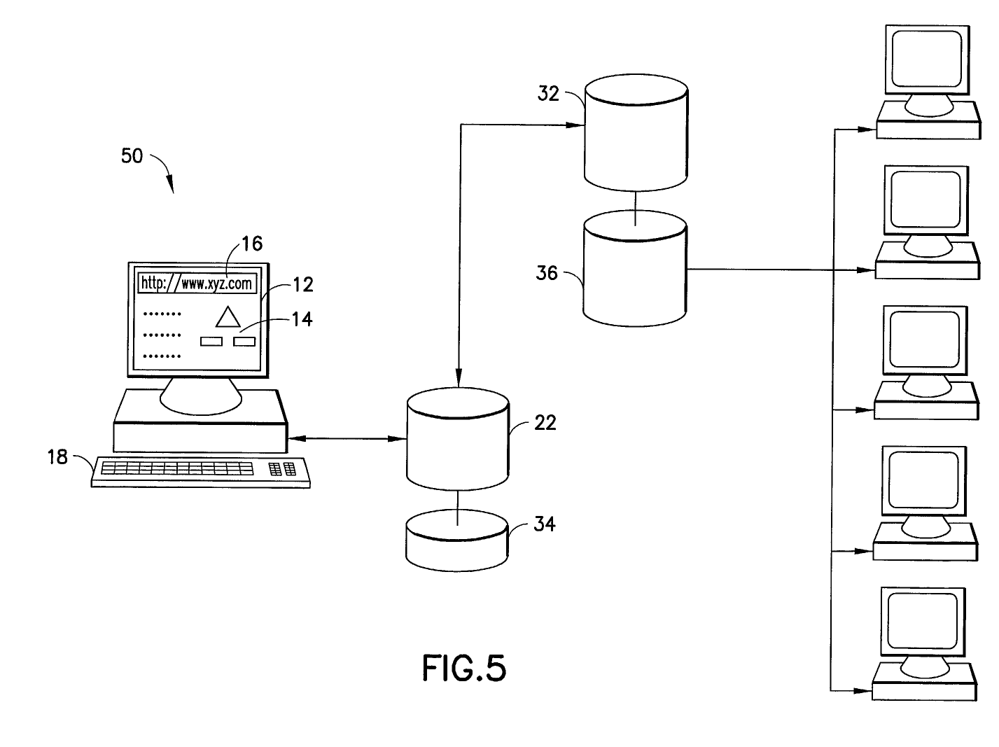

Referring now to the drawings which are provided to describe an embodiment of the invention and not by way of limitation, FIG. 1 contains a flow chart with an example of the process that may be followed to deliver dynamic information in the computer network illustrated in FIG. 5. Embodiments of the invention may be used to deliver any types of files or other digitally transmitted data in various types of computer networks such as local area networks (LANs), wide area networks (WANs), etc. In at least one embodiment of the invention, the computer network is the Internet, and the method will produce continuously updated HyperText Markup Language (HTML) files that produce web pages at a world wide web browser.

As shown in FIG. 1 and with reference to the network components of FIG. 5, the method is typically initiated when a user with an Internet browser 12 on a personal computer (PC) requests a web page 14 by entering a Universal Resource Locator (URL) 16 at a keyboard 18 as indicated in step 10. The URL is received by a computer network server 22 at step 20, which forwards the request to an information retrieval system 32 as indicated in step 30.

Information retrieval system 32 determines, at step 100, whether a copy of the requested web page 14 is present in a memory 34 that is linked to server 22. While memory 34 may be in the form of any media type, in at least one embodiment of the invention, memory 34 is a temporary memory such as a cache. However, those skilled in the art will recognize that the invention could be adapted for use with a local or networked permanent storage device. If a copy of requested web page 14 has been stored in memory 34, the page is retrieved from memory and forwarded to browser 12. More specifically, in at least one embodiment of the invention, the HTML file for the requested web page is copied from memory 34 as indicated in step 200, and transmitted to server 22 at step 300, which forwards the copied file to browser 12 at step 40.

If it is determined at step 100 that the requested web page 14 has not been stored in memory 34, information retrieval system 32 next executes step 400, rather than step 200. That is, information retrieval system 32 requests a fresh copy of the web page from an application server 36 that is accessible to the computer network. In one embodiment of the invention, application server 36 includes a database application development tool that is capable of creating “dynamic” web pages—web pages that are capable of supporting applications such as customer feedback, searching, on-line order-entry, bulletin boards and other user interactions with the network. An example of one such database application development tool is sold under the trade name COLDFUSION, by Allaire, Corp., Newton, Mass. Those skilled in the art will recognize that other products that allow for the development of complex applications, whether commercially available or created by individual users, may also be used. Once the requested web page 14 has been dynamically created by application server 36 at step 500, it will be transmitted to network server 22 as indicated in step 700 and stored in memory 34 as shown in step 600. While step 700 is illustrated as following step 600 in FIG. 1, it should be noted that steps 600 and 700 may take place simultaneously or step 700 may take place prior to step 600.

Once either a copy of the web page 14 is transmitted to network server 22 from cache at step 300, or a freshly created web page 14 is transmitted to network server 22 by application server 36 or another information source, network server 22 transmits the requested web page 14 to browser 12, as indicated in step 40.

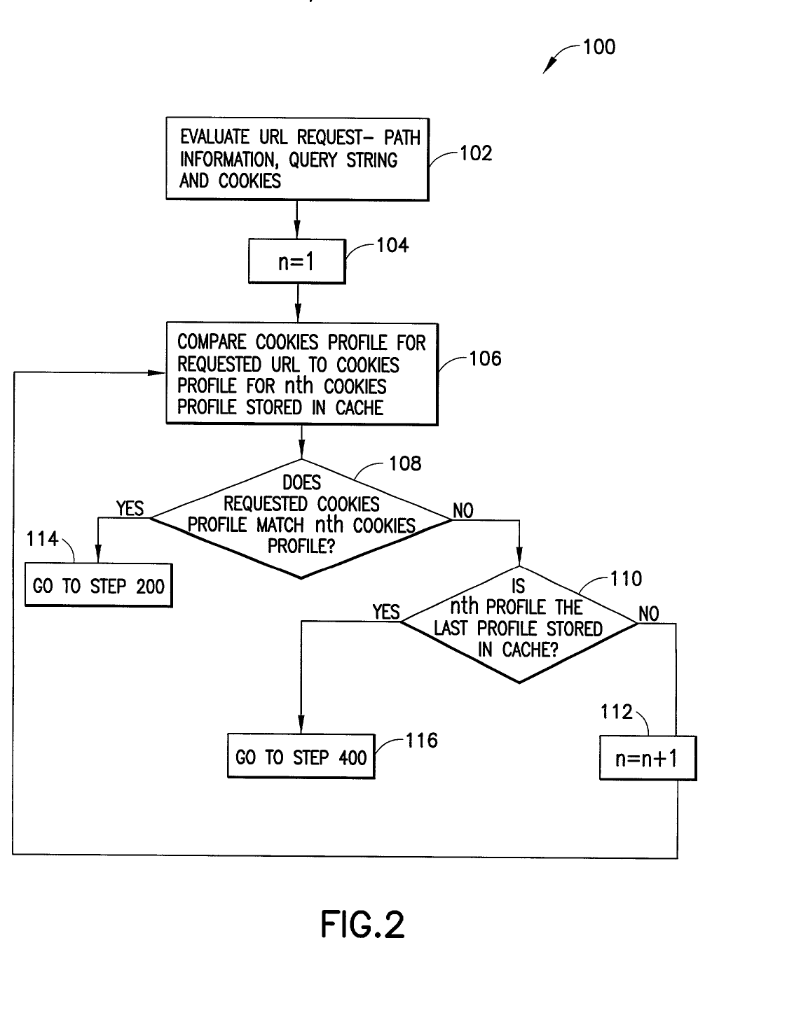

While the blocks shown in FIG. 1 may be accomplished in single steps, one or more of the desired outcomes are typically accomplished using multiple step processes. Turning to FIG. 2, for example, a detailed flow chart containing an exemplary multiple step process that may be followed to satisfy the task set forth in block 100—determining whether the requested web page 14 has been stored in memory 34—is provided. As shown in step 102, the URL request path, query string and cookies profile may be evaluated first. A counter may be initialized at step 104, to allow the cookies profile for the requested URL to be successively compared with each profile that is stored in memory 34, as indicated in steps 106 through 112. If the requested web page is stored in memory 34, its cookies profile will match a cookies profile for a file in the cache, and the method will be directed to step 200 (of FIG. 1) at step 114. Otherwise, the method will be directed to step 400 (of FIG. 1). Thus, by evaluating the requested URL and cookies and comparing them with a list of such data in a database inside the memory, the system can determine that a page has been cached when the request matches an existing file.

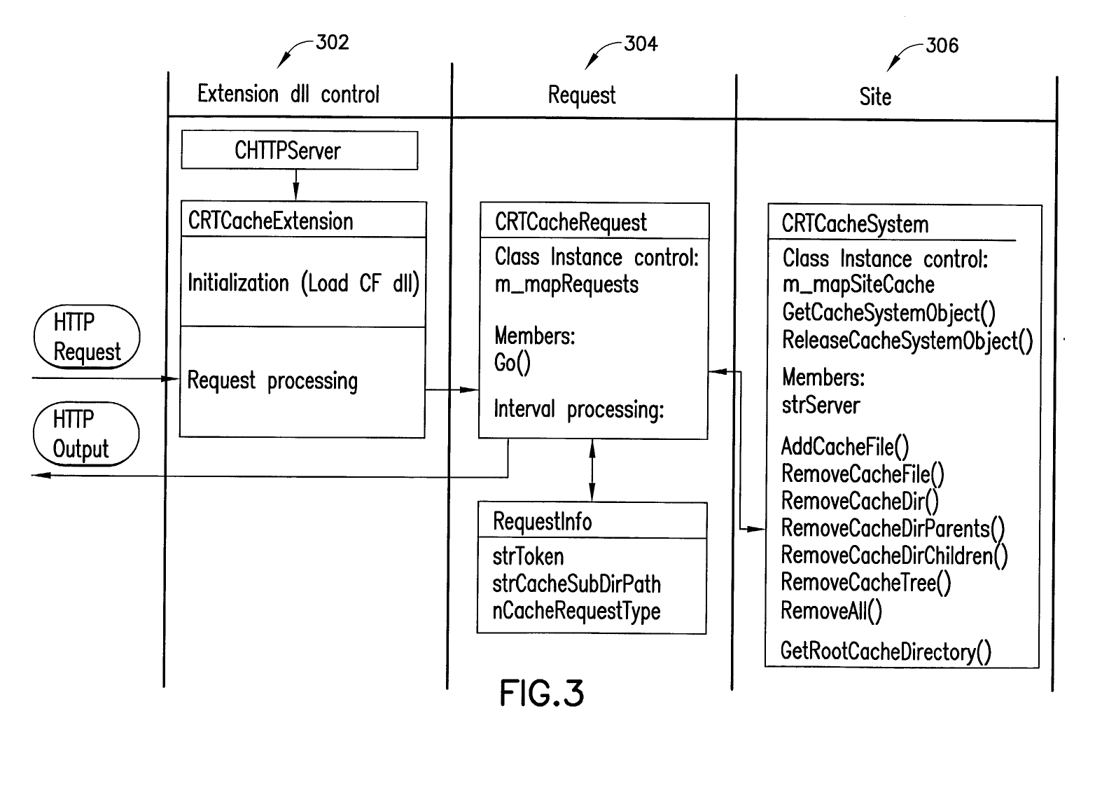

Turning now to FIG. 3, information retrieval system 32 may be implemented using an object oriented computer program. In the present embodiment of the invention, such a program will include three primary objects: an Extension d11 control class 302 which initializes execution, a Request class 304 which processes data associated with the page request, and executes a routing to evaluate the URL and a Site class 306 which stores site configuration options for each site for which caching has been enabled.

More specifically, Site class 306 is typically responsible for keeping site configuration options and cache control including a memory map of all cache files. The memory map may include a hash table that uses a request token as the key and a path to the cache file as the value. In one embodiment of the invention, a token is generated for each URL request. Generally speaking, a token is a unique combination of the request path, URL parameters and cookies. It is stored in the hash table so it can be quickly recalled and associated with a file in the cache that contains the contents of the HTML file identified by the URL. While Request class 304 is executed, an instance (which contains the procedures associated with Request class 304 as well as the data that is specific to the particulars of that object) is preferably created for every request. While Site class 306 is executed, one instance is preferably created for every site on the server.

Thus, when the first request is executed, information retrieval system 32 initializes site class 306, reads options from the operating system registry and establishes cache control functions. Each request is analyzed based upon (1) request path, (2) query string, and (3) cookies. A token uniquely identifies the file using these three components/structures, and tokens in memory 34 are searched to determine whether the requested page has previously been stored. In an embodiment of the invention such as that being described, each cached file has the following information associated with it:

virtual/physical directory which is extracted from the path information;

script including virtual/physical directory;

token; and

physical path on the hard drive of the server.

This information allows information retrieval system 32 to group cached files into virtual directories and scripts, so they can be controlled in groups, for example, by variations of the URL or by directory. After the URL request is evaluated, information retrieval system 32 checks to see if there is a file associated with the created Token already. If such a file exists, information retrieval system 32 returns it to computer network server 22, which sends the file back to browser 12. If the cache file for the request has not yet been created, information retrieval system 32 replaces the server callback frictions with its own to intercept computer network information source output and calls the information source (e.g. Internet Server Application Program Interface (ISAPI)) gateway the same way server would call the information source directly. After the output is intercepted, HTTP headers are analyzed. If content-type is text/http and there are no other headers, information retrieval system 32 returns the output to network server 22 to send back to browser 12, compresses the HTML and saves it on the disk, adding a memory map entry for the cache file.

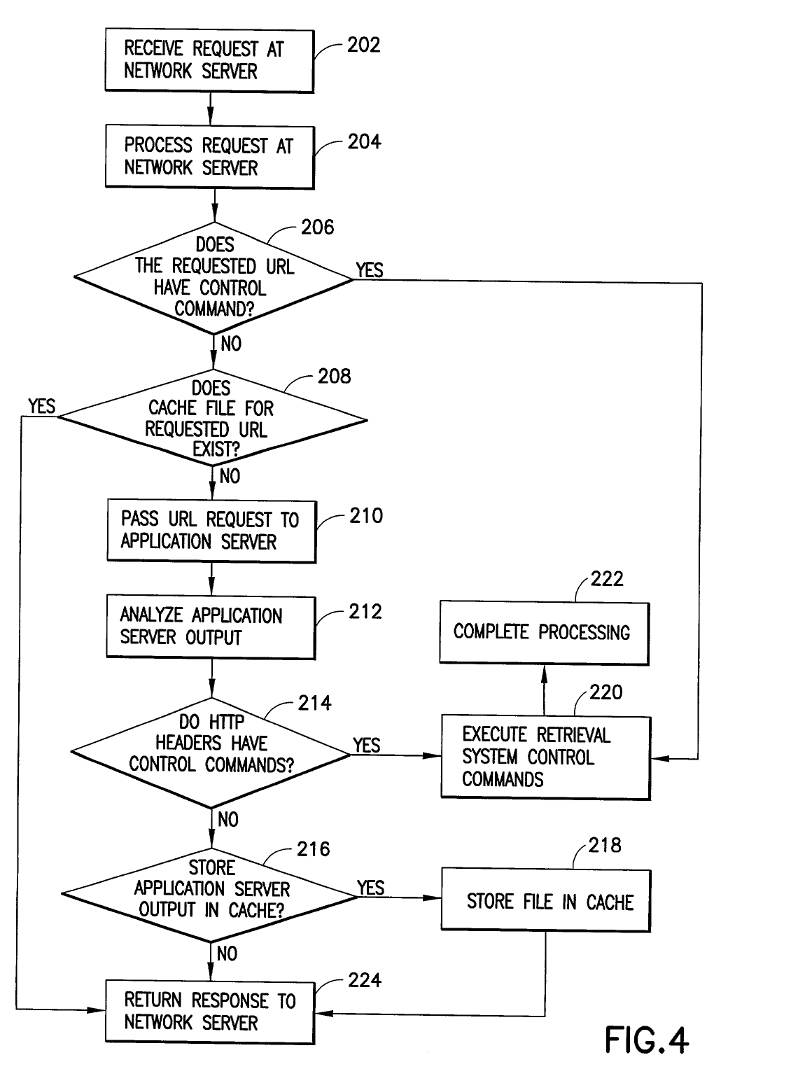

In the one embodiment of the invention, the method of delivering dynamic web pages 14 to an Internet browser 12 includes the steps that are illustrated in FIG. 4. As before, the method begins when a URL request is received at network server 22 as indicated in step 202. The request, which typically includes a path, followed by the script name and parameters is then processed at step 204. In this embodiment of the invention, processing of the request for information preferably includes analyzing the data in the request, parsing the request to create a token based on the URL parameters list and a specified cookie, and extracting the path information. Once the request for information has been processed, the URL parameters are used to determine whether the requested URL has control command. That is, the parameters are analyzed to determine whether certain actions can be taken with respect to the HTML file for the associated web page 14 (e.g. can it be copied, modified, etc.). If the URL has control command, those commands that are to be accessed by information retrieval system 32 are executed at step 220, and processing of the URL is completed at step 222, as will be further described below.

If the URL does not have control command, the method next determines at step 208 whether a file for the requested URL has previously been stored in cache 34. This step first requires determining whether the URL includes a “no cache” command. That is, whether the owner of the page at the requested URL has prohibited those who access the page from copying, and thus caching, the associated HTML file. If a no cache command exists, the requested web page 14 will be transmitted to browser 12 for viewing by the user at step 224, but no copy of the page will be stored. If the URL does not include a no cache command, the parameters will next be analyzed to determine whether there is a command, typically, but not necessarily, a HyperText Transfer Protocol (HTTP) “GET” request, during which the URL is passed to network server 22. The parameters may also be included. If such a request is present, web page 14 is transmitted to browser 12 for viewing by a user at step 224, but again, the page is not copied to cache 34.

If there is no HTTP “Get” request, the method next determines whether information retrieval system 32 has been pre-configured not to cache the particular web page 14. If so, again, the page is transmitted to browser 12 at step 224 without being copied to cache. If not, the method determines whether a cache file for the requested web page 14 has already been stored. If so, the method jumps to step 224 and transmits the previously stored file to browser 14. If not, the URL request is transmitted to application server 36 as indicated in step 210.

It should be noted here that information retrieval system 32 can be installed in the computer network as a stand alone application (e.g., as a proxy server) or as an extension of the operation of network server 22 (e.g., as a web-server in-process application). If information retrieval system 32 is installed as a proxy server (or other stand alone application), the URL request, is transmitted from the retrieval system to the web server, and is forwarded to application server 36 from the web server. If information retrieval system 32 is instead installed as a web-server in process application (or other network server extension), the request will be transmitted directly to application server 36. In any event, application server 36 will process the request, and return the requested web page 14 to information retrieval system 32.

Next, the web page that is returned to information retrieval system 32 from application server 36 is analyzed at step 212. This analysis will preferably include scanning the HTTP headers for information retrieval system control commands, and may optionally include scanning the entire output for application errors.

After the returned web page 14 is analyzed, the method determines at step 214 whether any headers in the HTTP file include control commands. If so, they are executed at step 220. Otherwise, the method proceeds to step 216 to determine whether the retrieved should be stored in the cache. This determination preferably includes a review of the HTTP headers to determine whether any commands that prohibit caching of the requested web page 14, whether any headers are unspecified or include unspecified cookies, and using text matching or some other suitable process, determine whether the page that has been received from application server 36 includes any errors. If any of these conditions are satisfied, the web page is transmitted to browser 12 at step 224 without storing a copy of the associated HTML file in the cache. If none of the conditions are satisfied, the received web page 14 is still transmitted to the browser at step 224, but a copy of the HTML file associated with the page is also stored in the cache as indicated in step 218. As the HTML file is stored, the file is also mapped in the cache, which enables it to be retrieved if the same page is requested again.

As indicated earlier, information retrieval system 32 may sometimes have to execute URL and/or HTTP header control commands at step 220, and may have to conduct further processing at step 222. Examples of URL and HTTP header control commands include the following:

| Command | Result |
|---|---|
| Delete File | removes cache file mapping associated |
| | with the specified URL/cookie |
| | combination |
| Delete Virtual Page | removes all cache file mappings associated |
| | with the specified virtual page |
| Delete Virtual Page and | removes all cache file mappings associated |
| all Siblings | with the specified virtual page and all |
| | sibling pages |
| Delete Virtual Page and | removes all cache file mappings associated |
| all Predecessors | with the specified virtual page and all |
| | predecessor pages |
| Delete Tree of Virtual Pages | removes all cache file mappings associated |
| | with the specified virtual page and from |
| | all virtual pages that belong to the same |
| | tree |
| Delete All Cache | removes all cache file mappings |

Information retrieval system 32 can execute any of these commands, preferably after it has been determined that users are authorized to execute such control commands. In one embodiment of the invention, control commands are received from a specified port that is dedicated to receiving control commands. In this embodiment, commands are validated prior to their execution at step 220. Numerous externally supplied applications can be used with information retrieval system 32. For example, a database “plug in,” can be provided to deliver control commands from extended stored procedures. Or, stored procedures can be written in C, for use with Oracle and an SQL Server to communicate with information retrieval system 32 using a protocol such as Transmission Control Protocol (TCP), or preferably, User Datagram Protocol (UDP). While embodiments of the invention could be adapted for use with any such protocol, a protocol such as UDP provides very few error recovery services, and instead, offers a direct way to send and receive datagrams over an Internet Protocol (IP) network. Such a procedure can be used in triggers and stored procedures, which extend the functionality of relational databases. Control commands that use UDP can also be supplied by user applications. These applications can be provided manually, or using special functions that have been written for the supported application servers (e.g. Java). Control commands that are supplied by users applications will preferably be delivered over the dedicated port and validated as described above.

In one embodiment of the invention, executing the commands described above does not actually cause the files to be removed from the cache. Instead, once the commands that cause files to be removed are executed, the removed file mappings are placed onto a “delete” list. A clean up thread then checks the list and removes the files that are no longer needed from the cache.

As illustrated in FIG. 5, the present invention may be embodied in a computer system that is capable of delivering dynamic information, which includes a computer network information server 22 configured to receive at least one request for information such as a URL 16 for a web page 14, and an information retrieval system 32 configured to accept the URL or other request for information from network server 22 and to return the requested web page 14 to network server 22. Information retrieval system 32 is further configured to: (i) determine web page 14 (or other information responsive to the request for information) is located in a memory 34 that is linked to network server 22, (ii) transmit the HTML file that is associated with the requested web page 14 from memory 34 to network server 22 if it is located in memory 34, (iii) request the HTML file that is associated with the requested web page 14 from an application server 36 if information the HTML file associated with the requested web page 14 is not located in memory 34, and (iv) transmit the HTML file that is received from application server 36 to network server 22. Information retrieval system 32 is integrated with the computer network information server and can be controlled directly by application server 36. Applications can thus, be created to modify content as needed.

As best illustrated in FIG. 5, the present invention can be embodied in a computer system 50. In one embodiment of the invention, information retrieval system 32 is linked to an ISAPI. However, those skilled in the art will recognize that it could be linked to a common gateway interface (CGI) or any device that will allow a server to transmit requests and requested information between a user and an application program.

In accordance with an embodiment of the invention, computer system 50 includes a database application network tool that is configured to enable computer network users to customize networked information. That is, users may submit orders, customer feedback, original text and numerous other types of individually generated information. The source of the information will typically be other computers that are connected to the computer network. These other computers or any other source of the networked information are capable of dynamically creating information that is responsive to the request for information.

It is, therefore, apparent that there has been provided, in accordance with the present invention, a method and apparatus for providing computer networked information. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method of delivering web pages to an Internet browser, comprising:
receiving, at an Internet server, a request from the Internet browser, for a page on the worldwide web;
determining whether a copy of said requested web page has been previously stored in a cache linked to said server;
if said requested web page has been previously stored in said cache, retrieving a copy of said requested web page from said cache and transmitting said retrieved copy to the Internet browser;
if said requested information has not been previously stored in said cache, retrieving said requested web page from a database application development tool, delivering said requested web page to said Internet browser, and storing a copy of said requested web page in said cache.

2. A method as claimed in claim 1 wherein the web page includes dynamic information.

3. A method as claimed in claim 1 wherein said determining step further comprises:
creating a profile for said requested web page; and
comparing said created profile with an existing profile associated with a web page stored in said cache.

4. A method as claimed in claim 1 wherein, when said created profile corresponds to said existing profile, said causing step further comprises retrieving a copy of said web page associated with said existing profile from said cache and transmitting said copy to said Internet browser.

5. A method as claimed in claim 1 wherein, when said created profile does not correspond to said existing profile, said causing step further comprises retrieving said requested web page from a database application development tool, delivering said retrieved web page to said Internet browser, and storing a copy of said retrieved web page in said cache.

6. A method as claimed in claim 1 wherein said identifier includes a cookies profile.

7. A method as claimed in claim 1 wherein said information in said memory includes a HyperText Markup Language file that describes a page on the world wide web.

8. A method as claimed in claim 1 wherein said request for information includes a Uniform Resource Locator for a page on the world wide web.

9. A method as claimed in claim 8 wherein said request for information includes a cookies profile.

10. A method as claimed in claim 1 wherein said requested information is submitted by a world wide web browser.

11. A method of obtaining information in a computer network, comprising:
receiving a request for information;
determining whether a copy of said requested information is present in a memory linked to said server;
if said requested information is present in said memory, causing a copy of said requested information to be retrieved from said memory;
if said requested information is not present in said memory, causing said requested information to be retrieved from a computer network information source and causing a copy of said retrieved information to be placed in said memory.

12. A method as claimed in claim 11 wherein said retrieved information includes dynamic information.

13. A method as claimed in claim 11 further comprising delivering said retrieved information to a user.

14. A method as claimed in claim 11 wherein said memory is a cache.

15. A method as claimed in claim 11 wherein said computer network is the Internet, and said requested information is a page on the world wide web.

16. A method as claimed in claim 11 wherein said determining step further comprises:
creating an identifier for said request for information; and
comparing said created identifier with at least one identifier that is associated with information in said memory.

17. A method as claimed in claim 16 wherein said identifier includes a cookies profile.

18. A method as claimed in claim 16 wherein said information in said memory includes a HyperText Markup Language file for said world wide web page.

19. A method as claimed in claim 11 wherein said computer network information source is a database application development tool.

20. A method as claimed in claim 11 wherein said request for information includes a Uniform Resource Locator for a page on the world wide web.

21. A method as claimed in claim 20 wherein said request for information includes a cookies profile.

22. A method as claimed in claim 11 wherein said information is requested using a world wide web browser.

23. A computer system capable of obtaining information, comprising:
a computer network information server configured to receive at least one request for information; and
an information retrieval system configured to accept said at least one request for information from said server and to return said requested information to said computer network information server, wherein said information retrieval system is further configured to:
(i) determine whether information responsive to said request for information is located in a memory linked to said computer network information server,
(ii) transmit said information responsive to said request for information to from said memory to said computer network information server if information responsive to said request for information is located in said memory,
(iii) request information responsive to said request for information from a computer network information source if information responsive to said request for information is not located in said memory,
(iv) transmit information received from said computer network information source to said computer network information server; and
(v) store a copy of said information received from said computer network information source in said memory.

24. A method as claimed in claim 23 wherein said retrieved information includes dynamic information.

25. A computer system as claimed in claim 23 wherein said memory includes a cache.

26. A computer system as claimed in claim 25 wherein said computer network is the Internet, and said requested information includes a page on the world wide web.

27. A computer system as claimed in claim 25 wherein said information retrieval system is linked to an Internet server application program interface.

28. A computer system as claimed in claim 25 wherein said information retrieval system is linked to a common gateway interface.

29. A computer system as claimed in claim 25 wherein said computer network information source includes a database application network tool configured to enable computer network users to customize networked information.

30. A computer system as claimed in claim 25 wherein said computer network information source is capable of dynamically creating information responsive to said request for information.

31. A computer system as claimed in claim 25 wherein said information in said memory includes a HyperText Markup Language file for a page on the world wide web.

32. A computer system as claimed in claim 25 wherein said request for information includes a Uniform Resource Locator for a page on the world wide web.

33. A computer system as claimed in claim 32 wherein said request for information includes a cookies profile.

34. A computer system as claimed in claim 25 wherein said requested information is submitted using a world wide web browser.
